(19) United States
(12) Patent Application Publication
(10) Pub. No.: US 2024/0185077 A1
(43) Pub. Date: Jun. 6, 2024

(54) APPARATUS AND METHOD WITH QUANTIZATION CONFIGURATOR

(71) Applicants: SAMSUNG ELECTRONICS CO., LTD., Suwon-si (KR); Seoul National University R&DB Foundation, Seoul (KR)

(72) Inventors: Seok-Young YOON, Suwon-si (KR); Bernhard EGGER, Seoul (KR); Daon PARK, Seoul (KR); Jungyoon KWON, Seoul (KR); Hyemi MIN, Seoul (KR)

(73) Assignees: SAMSUNG ELECTRONICS CO., LTD., Suwon-si (KR); Seoul National University R&DB Foundation, Seoul (KR)

(21) Appl. No.: 18/320,896

(22) Filed: May 19, 2023

(30) Foreign Application Priority Data
Dec. 1, 2022 (KR) 10-2022-0165989

(51) Int. Cl. G06N 3/086

(52) U.S. Cl. CPC G06N 3/086

(57) ABSTRACT

Apparatuses and methods for drawing a quantization configuration are disclosed, where A method may include generating genes by cataloging possible combinations of a quantization precision and a calibration method for each of layers of a pre-trained neural network, determining layer sensitivity for each of the layers based on combinations corresponding to the genes, determining priorities of the genes and selecting some of the genes based on the respective priority of the genes, generating progeny genes by performing crossover on the selected genes, calculating layer sensitivity for each of the layers corresponding to a combination of the crossover, and updating one or more of the genes using the progeny genes based on a comparison of layer sensitivity of the genes and layer sensitivity of the progeny genes.

### CROSS-REFERENCE TO RELATED APPLICATIONS

This application claims the benefit under 35 USC § 119(a) of Korean Patent Application No. 10-2022-0165989, filed on Dec. 1, 2022, in the Korean Intellectual Property Office, the entire disclosure of which is incorporated herein by reference for all purposes.

### BACKGROUND

### 1. Field

The following description relates to an apparatus and method for drawing a quantization configuration.

### 2. Description of Related Art

A deep neural network (DNN) may include several layers, and each layer may include numerous parameters. With the increase in the number of parameters, issues such as optimizing operation time and memory capacity may arise. In some examples, quantization techniques that change data types of parameters may be used to alleviate such issues.

An important consideration in quantization may be how to reduce the number of bits in an existing data type, i.e., how to set a quantization precision. After setting the quantization precision, a calibration method to be used during quantization may also be determined and the prediction accuracy may vary depending on the quantization precision and the calibration method.

Quantization may be applied to an entire DNN to maintain the greatest possible prediction accuracy, but the impact that quantization has on the performance of the DNN may be different for each layer. Accordingly, a process may be needed that determines the size of the data type of parameters that may be reduced for each layer.

It may take a long time to identify the best combination of quantization precision and calibration method for each layer of the DNN, which yields the highest prediction accuracy.

Genetic algorithms may be used to address an optimization issue. To apply a genetic algorithm, a solution may be represented in a genetic form and the fitness of the solution may be determined through a fitness function.

Genetic algorithms represent possible solutions for a problem in a data structure format, and then may gradually modify these solutions to produce better solutions. Here, the data structure representing the possible solutions may be called a gene, and a process of producing better solutions by transforming the possible solutions may be described as evolution.

In the genetic algorithm, the characteristics of a solution may be represented through a data structure, such as an array of numbers or a character string. An optimal solution may be derived by using a fitness function, which is a function for evaluating how appropriate a solution derived from the process is for the problem at hand.

The above description has been possessed or acquired by the inventor(s) in the course of conceiving the present disclosure and is not publicly known before the present application is filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a processor-implemented method of drawing a quantization configuration, the method including generating genes by cataloging possible combinations of a quantization precision and a calibration method for each of layers of a pre-trained neural network, determining layer sensitivity for each of the layers based on combinations corresponding to the genes, determining priorities of the genes and selecting some of the genes based on the respective priority of the genes, generating progeny genes by performing crossover on the selected genes, calculating layer sensitivity for each of the layers corresponding to a combination of the crossover, and updating one or more of the genes using the progeny genes based on a comparison of layer sensitivity of the genes and layer sensitivity of the progeny genes.

The determining of the layer sensitivity may include performing post training quantization (PTQ) on a first layer from among the layers, determining prediction accuracy of the pre-trained neural network by applying the PTQ to the first layer, and determining a difference between prediction accuracy of the pre-trained neural network and prediction accuracy obtained by applying the PTQ to the first layer.

The determining of the layer sensitivity may include determining a quantization precision available for the quantization configuration, and drawing a zero point and a scale factor corresponding to calibration available for the quantization configuration.

The determining of the priorities of the genes may include determining the priority of the genes using at least one of a Pareto-front or a crowding distance for each of the layers.

The selecting of some of the genes may include selecting some of the genes using at least one method of tournament selection or biased roulette wheel for each of the layers.

The generating of the progeny genes by performing the crossover may include selecting a reference point for the crossover.

The updating of some of the genes using the progeny genes, may include randomly changing one of the quantization precision and the calibration method of the combination of the crossover through a mutation process.

The method may include determining a quantization precision and a calibration method to be applied to each of the layers, considering the prediction accuracy of the neural network and a fitness evaluation function for energy.

The method may include re-training the pre-trained neural network based on the drawn quantization configuration to be applied to each of the layers.

In another general aspect, there is provided an apparatus for drawing a quantization configuration, the apparatus including a memory configured to store one or more programs, and one or more processors configured to execute the one or more programs to configure the one or more processors to generate genes by cataloging possible combinations of a quantization precision and a calibration method for each of layers of a pre-trained neural network, determine layer sensitivity for each of the layers based on combinations corresponding to the genes, determine priorities of the genes and select some of the genes based on the respective priority of the genes, generate progeny genes by performing crossover on the selected genes, calculate layer sensitivity for each of the layers corresponding to a combination of the crossover, and update one or more of the genes using the progeny genes based on a comparison of layer sensitivity of the genes and layer sensitivity of the progeny genes.

The one or more processors may be configured to perform post training quantization (PTQ) on a first layer from among the layers, determine prediction accuracy of the pre-trained neural network obtained by applying the PTQ to the first layer with respect to the pre-trained neural network, and determine a difference between prediction accuracy of the pre-trained neural network and prediction accuracy obtained by applying the PTQ to the first layer.

The one or more processors may be configured to determine a quantization precision available for the quantization configuration, and draw a zero point and a scale factor corresponding to calibration available for the quantization configuration.

The one or more processors may be configured to determine the priority of the genes using at least one of a Pareto-front or a crowding distance for each of the layers.

The one or more processors may be configured to select some of the genes using at least one method of tournament selection or biased roulette wheel for each of the layers.

The one or more processors may be configured to generate the progeny genes by performing the crossover based on selecting a reference point for the crossover.

The one or more processors may be configured to randomly change one of the quantization precision and the calibration method of the combination of the crossover through a mutation process.

The one or more processors may be configured to determine a quantization precision and a calibration method to be applied to each of the layers, considering the prediction accuracy of the neural network and a fitness evaluation function for energy.

The one or more processors may be configured to re-train the pre-trained neural network based on the drawn quantization configuration to be applied to each of the layers.

The one or more processors may be configured to determine a quantization precision and a calibration method to be applied to each of the layers based on a fitness evaluation function.

Other features and aspects will be apparent from the following detailed description, the drawings, and the claims.

### BRIEF DESCRIPTION OF THE DRAWINGS

FIG. 1 illustrates an example of an operation of an apparatus for drawing a quantization configuration, according to one or more embodiments.

FIG. 2 illustrates an example of a method of an apparatus for drawing a quantization configuration, according to one or more embodiments.

FIG. 3 illustrates an example of a method of a genetic algorithm, according to one or more embodiments.

FIG. 4 illustrates an example of a configuration of an apparatus for drawing an optimal quantization configuration, according to one or more embodiments.

FIG. 5 illustrates an example of a configuration of an electronic device, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, portions, or sections, these members, components, regions, layers, portions, or sections are not to be limited by these terms. Each of these terminologies is not used to define an essence, order, or sequence of corresponding members, components, regions, layers, portions, or sections, for example, but used merely to distinguish the corresponding members, components, regions, layers, portions, or sections from other members, components, regions, layers, portions, or sections. Thus, a first member, component, region, layer, portions, or section referred to in the examples described herein may also be referred to as a second member, component, region, layer, portions, or section without departing from the teachings of the examples.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing. As used herein, the term “and/or” includes any and all combinations of one or more of the associated listed items. For example, “A and/or B” may be interpreted as “A,” “B,” or “A and B.”

The terminology used herein is for the purpose of describing particular examples only and is not to be limiting of the examples. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the examples with reference to the accompanying drawings, like reference numerals refer to like constituent elements and a repeated description related thereto will be omitted. In the description of the examples, a detailed description of well-known related structures or functions will be omitted when it is deemed that such description may be redundant or cause ambiguous interpretation of the present disclosure.

The same name may be used to describe an element included in the examples described above and an element having a common function. Unless otherwise mentioned, the descriptions of the examples may be applicable to the following examples and thus, duplicated descriptions will be omitted for conciseness.

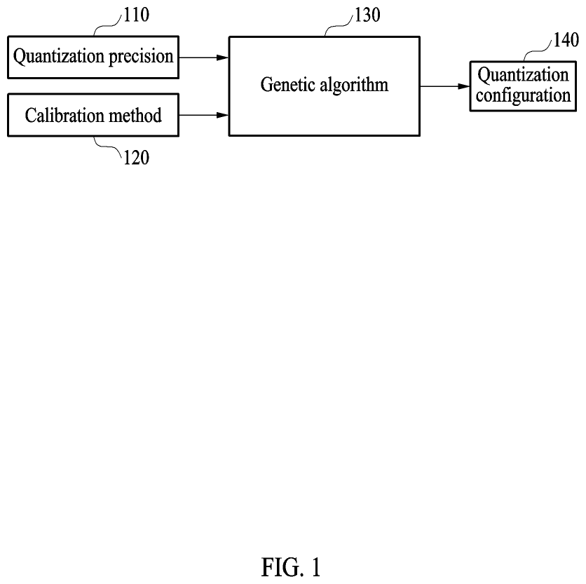

FIG. 1 illustrates an example of an operation of an apparatus for drawing a quantization configuration, according to one or more embodiments.

Referring to FIG. 1, the apparatus may draw or generate an optimal quantization configuration 140, based on quantization precision information 110 and quantization calibration information 120. The apparatus may utilize a genetic algorithm 130 to draw or generate a quantization configuration 140 for a neural network.

The neural network may include a plurality of layers. The plurality of layers may include an input layer, at least one hidden layer, and an output layer. The neural network may be a convolutional neural network. In the non-output layers, an input image or map may be convolved with filters/kernels, and as a result, a plurality of intermediate feature maps may be generated. The intermediate feature maps may be again convoluted in a subsequent convolutional layers as input feature maps with another kernel of the subsequent layers, and new intermediate feature maps may be output. After the convolution operations are repeatedly performed, and potentially, other layer operations performed, the recognition or classification results of features of the input image (e.g., as generated by the output layer, e.g., a fully connected layer) may be output through the neural network.

The neural network, convolutional neural network (CNN), or deep neural network (DNN) may generate mapping between input information and output information, and may have a generalization capability to infer a relatively correct output with respect to input information that has not been used for training. The neural network may be a general model that has an ability to solve a problem or perform tasks, as non-limiting examples, where nodes arranged in layers form the network through connections and other parameters are adjusted through training.

In some examples, training an artificial neural network may involve determining and adjusting weights and biases between layers or weights and biases among a plurality of nodes belonging to different layers adjacent to one another, as only non-limiting examples of such parameters.

The apparatus may be provided with quantization precision methods and data for calibration, such as a zero point and a scale factor. For example, the quantization precision methods may include methods, for example, precisions for INT8, SINT8, FP16, FP32, and the like, while quantization calibration methods may include methods, for example, for quantization functions max, percentile, entropy, and the like. In some examples, the quantization precision methods and the calibration methods may correspond to the number m and the number n, respectively. In addition, a genetic algorithm may be applied to each layer of a neural network so as to derive an optimal quantization configuration for each respective layer.

Each method may be defined as genes for determining a quantization configuration. Thus, a population including m number×n number of genes may be created for the quantization precision methods and the calibration methods. Some genes may be selected from among the m×n number of genes according to a genetic algorithm, the selected genes may be passed through crossover and mutation operations, a fitness evaluation function may be calculated for the thus-transformed selected genes, and then a quantization configuration may be determined for each layer based on a result of the calculation.

The quantization precision and calibration method may be evaluated with a fitness evaluation function, scoring the selected genes' quantization precision and calibration method based on their suitability. In some examples, the fitness evaluation function may be predetermined. In some examples, a function related to quantization precision and energy usage may be used as the fitness evaluation function, and weights about the two evaluation items of quantization precision and energy usage may be applied to the function based on user parameters. For example, a higher quantization accuracy may lead to higher energy consumption, and a lower quantization accuracy may lead to lower energy consumption, so the user parameters may be appropriately set for the two evaluation items.

A genetic algorithm may be used for optimization problems. The genetic algorithm may increase the likelihood of a good solution surviving to be selected as the final answer by encoding a set of possible solutions as integer vectors and going through evolutionary processes such as, for example, selection, crossover, mutation, fitness calculation, and sorting. As described above, various judgment criteria may determine how good a solution is, such as, for example, quantization accuracy and energy consumption, which can be quantified and expressed as a fitness function. In addition, genetic operations may be modified to meet the requirements of given problems. The embodiments described herein may optimize the quantization structure (or functions/parameters) for each layer constituting the neural network by applying a genetic algorithm using data on applicable quantization structures for determining the quantization precision and calibration method for quantization.

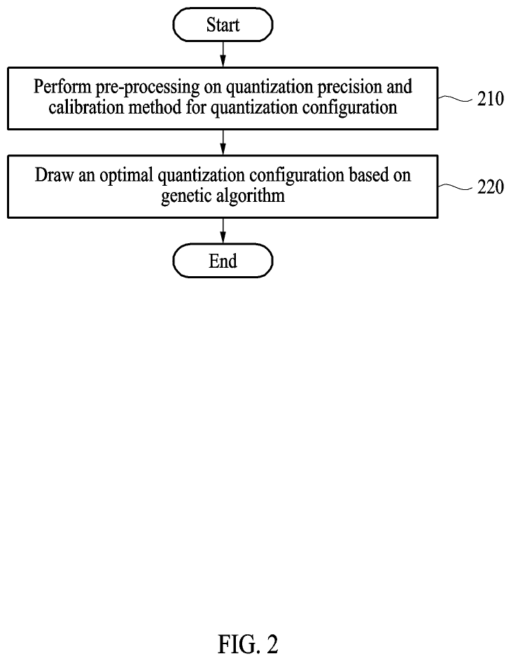

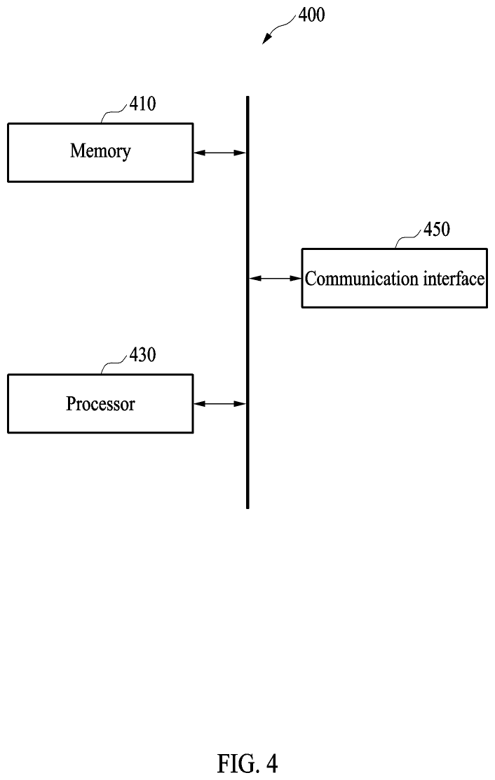

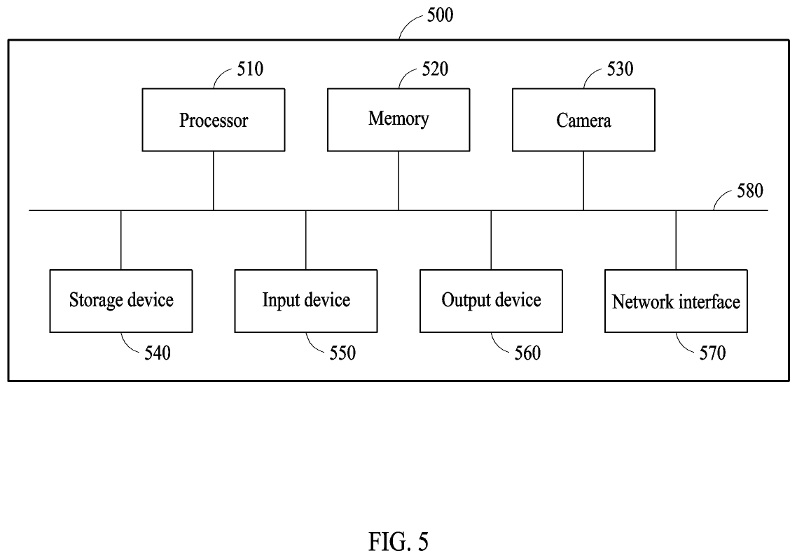

FIG. 2 illustrates an example of a method of an apparatus for drawing or generating a quantization configuration, according to one or more embodiments. One or more blocks of FIG. 2, and combinations of the blocks, can be implemented by special purpose hardware-based computer that perform the specified functions, or combinations of special purpose hardware and instructions, e.g., computer or processor instructions. For example, operations of the method may be performed by a computing apparatus (e.g., apparatus 400 of FIG. 4 or electronic device 500 of FIG. 5). In addition to the description of FIG. 2 below, the descriptions of FIGS. 1 and 3-5 are also generally applicable to FIG. 2.

In operation 210, the apparatus may perform pre-processing on a quantization precision and a calibration method for a quantization configuration.

Layer sensitivity may be calculated in advance for all quantization configurations that may be drawn or generated through a combination of a quantization precision and a calibration method for some or all layers included in a neural network. The neural network to be quantized may correspond to a neural network of a pre-trained deep neural network (DNN).

In the preprocessing operation, the apparatus may generate a population including a plurality of genes by listing possible combinations of the quantization precision and the calibration method for each of the multiple layers of the pre-trained neural network and may calculate layer sensitivity for each of the layers based on the corresponding combinations of the plurality of genes.

The apparatus may calculate the layer sensitivity for all the generated population representing all quantization configurations after calculating zero points and scale factors of all layers. To calculate the layer sensitivity, the apparatus may calculate a difference between quantization precision of the pre-trained neural network and quantization precision obtained after performing training with respect to a layer in a post-training quantization method. In such a manner, preprocessing of other performance indicators may be performed for all genes. The calculated layer sensitivity may be utilized during progression of the genetic algorithm.

In operation 220, the apparatus may draw or generate an optimal quantization configuration based on the genetic algorithm.

An optimal configuration for a layer may be drawn or generated for genes using the combinations of the quantization precision and the calibration method through evolutionary processes, such as selection, crossover, mutation, fitness calculation, and sorting of the genetic algorithms for the genes.

The genetic algorithm may be executed not only to optimize quantization precision but also to enhance other performance aspects, such as, for example, optimizing energy usage of a neural network. To this end, a fitness evaluation function for the quantization precision and energy usage may be defined.

For example, upon determination of quantization precision of each layer, the performance of the energy usage may be measured to identify a trade-off relationship between performances of both the quantization precision and the energy usage. In the fitness evaluation function, user parameters may be defined for applying weights to both performances.

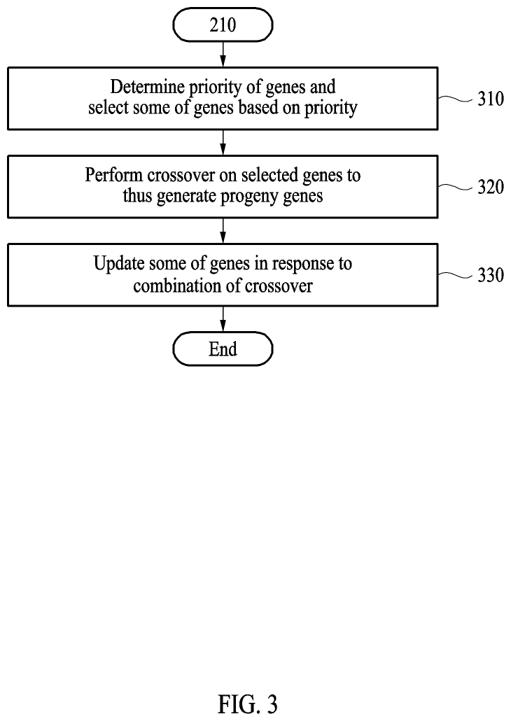

The operation method of the quantization algorithm is further described with reference to FIG. 3 below.

FIG. 3 illustrates an example of a method of a genetic algorithm, according to one or more embodiments. One or more blocks of FIG. 3, and combinations of the blocks, can be implemented by special purpose hardware-based computer that perform the specified functions, or combinations of special purpose hardware and instructions, e.g., computer or processor instructions. For example, operations of the method may be performed by a computing apparatus (e.g., apparatus 400 of FIG. 4 or electronic device 500 of FIG. 5). In addition to the description of FIG. 3 below, the descriptions of FIGS. 1-2 and 4-5 are also applicable to FIG. 2.

An apparatus may derive an optimized quantization configuration for each layer by applying a genetic algorithm using a preprocessed value described with reference to FIG. 2

In operation 310, the apparatus may determine a priority of genes and select some of the genes based on the priority.

The apparatus may determine the priority of the genes by using a Pareto-front and/or a crowding distance for each layer and establishing a ranking system.

Once the priority is determined, some of the genes may be selected according to the priority. For each layer, some combinations may be selected from the priority based on at least one of tournament selection and a biased roulette wheel method.

In operation 320, the apparatus may perform crossover on the selected genes to generate progeny genes.

When genes for generating the next progeny genes are selected, a reference point for the crossover may be selected. In some examples, the reference point for the crossover may be selected by a user's setting.

In operation 330, the apparatus may update some of the genes in response to a combination of the crossover.

For example, the apparatus may calculate layer sensitivity for each of the layers in response to the combination of the crossover, and update some of the genes in the population with the progeny genes by comparing layer sensitivity included in the population to layer sensitivity of the progeny genes.

The apparatus may update some of the genes with different random contents and determine a quantization precision and a calibration method to be applied to each of the layers considering a fitness evaluation function using some of the updated genes. When the fitness evaluation function is not satisfied, the apparatus may re-iterate selection, crossover, and mutation (update) operations and may thus generate new progeny genes. The genes may evolve according to such iteration.

As described above, the fitness evaluation function may use functions related to quantization precision and energy usage, and weights for the two evaluation items of quantization accuracy and energy usage may be applied to the function, based on user parameters.

The operation of the genetic algorithm may be implemented through the fitness evaluation function. The genetic algorithm may be performed with high fitness genes having a high probability.

When a genetic algorithm, such as selection, crossover, and upgrade, is implemented, an evolution process may be iterated based on the genetic algorithm. A population may be a set of possible candidate genes. When the population includes a large number of candidate genes, selection options may increase but a computation time may also increase. Each solution may be rearranged according to priority based on the degree of fitness in each evolution process.

Since it may be unknown what degree of fitness an optimal gene has before the evolution process is terminated, the apparatus may iterate the evolution process to a certain number of times and determine, to be a final solution, a solution with the greatest fitness among solutions obtained through the certain number of times. In this case, the solutions obtained through the certain number of times may converge into a specific solution in the evolution process.

A pretrained neural network may be retrained based on a quantization configuration to be applied to each of the layers in the example.

FIG. 4 illustrates an example of an apparatus for drawing or generating an optimal quantization configuration, according to one or more embodiments.

An apparatus 400 may include a memory 410, one or more processors 430, and a communication interface 450. One or more programs that are stored in the memory 410 may be executed by the one or more processors 430.

The memory 410 may store computer-readable instructions. When the instructions stored in the memory 410 are executed by the one or more processors 430, the one or more processors 430 may process operations defined by the instructions. The memory 410 may store a neural network or a DNN, such as the DNN described above. The memory 410 may be connected to the one or more processors 430 and store instructions executable by the one or more processors 430, data to be computed by the one or more processors 430, or data processed by the one or more processors 430. However, this is only an example, and the information stored in the memory 410 is not limited thereto. In an example, the memory 410 may store a program (or an application, or software). The stored program may be a set of syntaxes that are coded and executable by the one or more processors 430 to operate the apparatus 400. The memory 410 may include a volatile memory or a non-volatile memory. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), or an insulator resistance change memory. Further details regarding the memory 410 are provided below.

The processor 430 may execute the instructions stored in the memory 410 to perform the operations described above with reference to FIGS. 1 to 3. For example, the processor 430 may generate a population including a plurality of genes by listing possible combinations of a quantization precision and a calibration method for each of layers of a pre-trained neural network, may calculate layer sensitivity for each of the layers based on the combinations corresponding to the plurality of genes, may determine a priority of genes, and may select some of the genes based on the priority. The processor 430 may perform crossover on the selected genes to generate progeny genes, calculate layer sensitivity for each of the layers corresponding to the crossover combinations, and compare layer sensitivity included in the population to layer sensitivity of the progeny genes such that some of the genes included in the population may be updated using the progeny genes. In addition, the processor 430 may determine a quantization precision and a calibration method to be applied to each of the layers considering the fitness evaluation function for prediction accuracy and energy of the neural network. In some examples, the processor 430 may retrain the pretrained neural network based on a quantization configuration to be applied to each of the layers.

The processor 430 may be a hardware-implemented apparatus having a circuit that is physically structured to execute desired operations. The desired operations may include code or instructions included in a program stored in the memory 410. The hardware-implemented data processing device 430 may include, for example, a main processor (e.g., a central processing unit (CPU), a field-programmable gate array (FPGA), or an application processor (AP)) or an auxiliary processor (e.g., a GPU, a neural processing unit (NPU), an image signal processor (ISP), a sensor hub processor, or a communication processor (CP)) that is operable independently of, or in conjunction with the main processor. Further details regarding the processor 430 are provided below.

The processor 430 may read/write neural network data, for example, image data, feature map data, kernel data, biases, weights, for example, connection weight data, hyperparameters, and other parameters etc., from/to the memory 410 and implement the neural network, such as the DNN described above, using the read/written data. When the neural network is implemented or each layer of the DNN is optimized, the processor 430 may repeatedly perform operations between an input and parameters, in order to generate data with respect to an output. Here, in an example convolution layer, a number of convolution operations may be determined, depending on various factors, such as, for example, the number of channels of the input or input feature map, the number of channels of the kernel, a size of the input feature map, a size of the kernel, number of the kernels, and precision of values. Such a neural network may be implemented as a complicated architecture, where the processor 430 performs convolution operations with an operation count of up to hundreds of millions to tens of billions, and the frequency at which the processor 430 accesses the memory 410 for the convolution operations rapidly increases.

The processor 430 may execute a program to control the apparatus 400. Code of the program to be executed by the processor 430 may be stored in the memory 410. The apparatus 400 may be connected to an external device (e.g., a personal computer (PC) or a network) or an input/output device (not shown) to exchange data therewith through the communication interface 450.

In some examples, the apparatus 400 may be implemented as, or in, various types of computing devices, such as, a personal computer (PC), a data server, or a portable device. In an example, the portable device may be implemented as a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), or a smart device. In an example, the computing devices may be a wearable device, such as, for example, a smart watch and an apparatus for providing augmented reality (AR) (hereinafter simply referred to as an AR provision device) such as AR glasses, a head mounted display (HMD), various Internet of Things (IoT) devices that are controlled through a network, and other consumer electronics/information technology (CE/IT) devices.

FIG. 5 illustrates an example of a configuration of an electronic device, according to one or more embodiments.

Referring to FIG. 5, an electronic device 500 may include a processor 510, a memory 520, a camera 530, a storage device 540, an input device 550, an output device 560, and a network interface 570, and these components may communicate with one another through a communication bus 580. The description of the processor 430, the memory 410, and the communication interface 450 of FIG. 14 are applicable to the processor 510, the memory 520, and network interface 570 of FIG. 5, respectively, and will not be repeated for brevity.

In some examples, the electronic device 500 may be implemented as, or in, various types of computing devices, such as, a personal computer (PC), a data server, or a portable device. In an example, the portable device may be implemented as a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), or a smart device. In an example, the computing devices may be a wearable device, such as, for example, a smart watch and an apparatus for providing augmented reality (AR) (hereinafter simply referred to as an AR provision device) such as AR glasses, a head mounted display (HMD), various Internet of Things (IoT) devices that are controlled through a network, and other consumer electronics/information technology (CE/IT) devices. The electronic device 500 may include, structurally and/or functionally, the apparatus 400 of FIG. 4.

The camera 530 may capture a photo and/or a video. The storage device 540 may include a non-transitory computer-readable storage medium or a non-transitory computer-readable storage device. The storage device 540 may store a greater amount of information than the memory 520 and store the information for a long period of time. For example, the storage device 540 may include a magnetic hard disk, an optical disk, a flash memory, a floppy disk, or other non-volatile memories known in the art.

The input device 550 may receive an input from a user through a traditional input scheme using a keyboard and a mouse and through a new input scheme such as a touch input, a voice input, and an image input. The input device 550 may include, for example, a keyboard, a mouse, a touchscreen, a microphone, and other devices that may detect an input from a user and transmit the detected input to the electronic device 500. The output device 560 may provide an output of the electronic device 500 to a user through a visual, auditory, or tactile channel. The output device 560 may include, for example, a display, a touch screen, a speaker, a vibration generator, or any other device that provides an output to a user. The output device 560 is not limited to the example described above, and any other output device, such as, for example, computer speaker and eye glass display (EGD) that are operatively connected to the electronic device 500 may be used without departing from the spirit and scope of the illustrative examples described. In an example, the output device 560 is a physical structure that includes one or more hardware components that provide the ability to render a user interface, output information and speech, and/or receive user input. The network interface 570 may communicate with an external device through a wired or wireless network.

The computing apparatuses, the electronic devices, the processors, the memories, and other components described herein with respect to FIGS. 1-5 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in the figures that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A processor-implemented method of generating a quantization configuration, the method comprising:
generating genes by cataloging possible combinations of a quantization precision and a calibration method for each of layers of a pre-trained neural network;
determining layer sensitivity for each of the layers based on combinations corresponding to the genes;
determining priorities of the genes and selecting some of the genes based on the respective priorities of the genes;
generating progeny genes by performing crossover on the selected genes;
calculating layer sensitivity for each of the layers corresponding to a combination of the crossover; and
updating one or more of the genes using the progeny genes based on a comparison of layer sensitivity of the genes and layer sensitivity of the progeny genes.

2. The method of claim 1, wherein the determining of the layer sensitivity comprises:
performing post training quantization (PTQ) on a first of the layers;
determining prediction accuracy of the pre-trained neural network by applying the PTQ to the first layer; and
determining a difference between prediction accuracy of the pre-trained neural network and prediction accuracy obtained by applying the PTQ to the first layer.

3. The method of claim 1, wherein the determining of the layer sensitivity comprises:
determining a quantization precision available for the quantization configuration; and
generating a zero point and a scale factor corresponding to calibration available for the quantization configuration.

4. The method of claim 1, wherein the determining of the priorities of the genes comprises determining the priority of the genes using at least one of a Pareto-front or a crowding distance for each of the layers.

5. The method of claim 1, wherein the selecting of some of the genes comprises selecting some of the genes using tournament selection or biased roulette wheel for each of the layers.

6. The method of claim 1, wherein the generating of the progeny genes by performing the crossover comprises selecting a reference point for the crossover.

7. The method of claim 1, wherein the updating of some of the genes using the progeny genes, comprises
randomly changing the quantization precision and/or the calibration method of the combination of the crossover through a mutation process.

8. The method of claim 1, further comprising determining a quantization precision and a calibration method to be applied to each of the layers, considering the prediction accuracy of the neural network and a fitness evaluation function for energy.

9. The method of claim 1, further comprising re-training the pre-trained neural network based on the generated quantization configuration to be applied to each of the layers.

10. A non-transitory computer-readable storage medium storing instructions that, when executed by a processor, cause the processor to perform the method of claim 1

11. An apparatus for generating a quantization configuration, the apparatus comprising:
a memory configured to store instructions; and
one or more processors configured to execute the instructions to configure the one or more processors to:
generate genes by cataloging possible combinations of a quantization precision and a calibration method for each of layers of a pre-trained neural network;
determine layer sensitivity for each of the layers based on combinations corresponding to the genes;
determine priorities of the genes and select some of the genes based on the respective priority of the genes;
generate progeny genes by performing crossover on the selected genes;
calculate layer sensitivity for each of the layers corresponding to a combination of the crossover; and
update one or more of the genes using the progeny genes based on a comparison of layer sensitivity of the genes and layer sensitivity of the progeny genes.

12. The apparatus of claim 11, wherein the one or more processors are further configured to:
perform post training quantization (PTQ) on a first layer from among the layers;
determine prediction accuracy of the pre-trained neural network obtained by applying the PTQ to the first layer with respect to the pre-trained neural network; and
determine a difference between prediction accuracy of the pre-trained neural network and prediction accuracy obtained by applying the PTQ to the first layer.

13. The apparatus of claim 11, wherein the one or more processors are further configured to:
determine a quantization precision available for the quantization configuration; and
generating a zero point and a scale factor corresponding to calibration available for the quantization configuration.

14. The apparatus of claim 11, wherein the one or more processors are further configured to determine the priority of the genes using at least one of a Pareto-front or a crowding distance for each of the layers.

15. The apparatus of claim 11, wherein the one or more processors are further configured to select some of the genes using at least one method of tournament selection or biased roulette wheel for each of the layers.

16. The apparatus of claim 11, wherein the one or more processors are further configured to generate the progeny genes by performing the crossover based on selecting a reference point for the crossover.

17. The apparatus of claim 11, wherein the one or more processors are further configured to randomly change one of the quantization precision and the calibration method of the combination of the crossover through a mutation process.

18. The apparatus of claim 11, wherein the one or more processors are further configured to determine a quantization precision and a calibration method to be applied to each of the layers, considering the prediction accuracy of the neural network and a fitness evaluation function for energy.

19. The apparatus of claim 11, wherein the one or more processors are further configured to re-train the pre-trained neural network based on the generated quantization configuration to be applied to each of the layers.

20. The apparatus of claim 11, wherein the one or more processors are further configured to determine a quantization precision and a calibration method to be applied to each of the layers based on a fitness evaluation function.
